(19) United States
(12) Patent Application Publication
(10) Pub. No.: US 2018/0196854 A1
(43) Pub. Date: Jul. 12, 2018

(54) APPLICATION EXTENSION FOR GENERATING AUTOMATIC SEARCH QUERIES

(71) Applicant: Google Inc., Mountain View, CA (US)

(72) Inventor: Michael Burks, Los Altos, CA (US)

(21) Appl. No.: 15/403,822

(22) Filed: Jan. 11, 2017

(51) Int. Cl. G06F 17/30; G06F 3/0488; G06F 3/0482

(52) U.S. Cl. CPC G06F 17/30554; G06F 17/3053; G06F 3/0482; G06F 3/04886; G06F 17/30867

(57) ABSTRACT

In general, this disclosure is directed to techniques for enabling an application extension executing as part of an application of a computing device to: automatically predict, based on contextual information associated with the computing device or the application, potential search queries from a set of predetermined search queries, and display graphical elements (e.g., icons, images, or other types of graphical elements) indicative of the predicted search queries within the graphical keyboard. The application extension may analyze the contextual information for use in the search query prediction only after receiving express consent from a user of the computing device to do so. The application extension may execute, or cause to be executed, a search based on a predicted search query in response to the computing device detecting a user input that selects, from directly within the graphical keyboard, the graphical element that is associated with the predicted search query.

### BACKGROUND

Despite being able to simultaneously execute several applications, some mobile computing devices can only present a graphical user interface (GUI) of a single application, at a time. A user of a mobile computing device may have to provide input to switch between different application GUIs to complete a particular task. For example, a user of a mobile computing device may have to cease entering text in a messaging application, provide input to cause the device toggle to a search application, manually enter a potentially lengthy search query within the search application, and provide still yet additional input at a GUI of the search application to search for a particular piece of information that the user may want to finish composing a message or otherwise entering text in the messaging application. Providing several inputs required by some computing devices to perform various tasks can be tedious, repetitive, and time consuming.

### SUMMARY

In general, this disclosure is directed to techniques for enabling an application extension executing within an application that utilizes a graphical keyboard of a computing device to automatically predict, based on contextual information associated with the computing device and the application, potential search queries from a set of predetermined search queries, and display graphical elements (e.g., icons, images, or other types of graphical elements) indicative of the predicted search queries within the graphical keyboard. The application extension may analyze the contextual information for use in the search query prediction only after receiving express consent from a user of the computing device to do so. The application extension may execute, or cause to be executed, a search based on a predicted search query in response to the computing device detecting a user input that selects, from directly within the graphical keyboard, the graphical element that is associated with the predicted search query.

The application extension may automatically generate and display one or more results of the executed search within at least a portion of the graphical keyboard. After displaying the search results, the computing device may receive additional user input (e.g., voice, touch, etc.) that selects one of the displayed search results. In response to the additional user input, the application extension may cause the computing device to display additional information associated with the result and/or input the result in a message that may later be sent to a recipient computing device, thereby enabling the user of the computing device to easily share search results with users of other computing devices.

By providing executing an application extension having integrated search query prediction, an example computing device may provide a way for a user to quickly obtain search results that are relevant to the various contexts associated with the computing device without having to switch between several different applications, manually input lengthy search queries using the graphical keyboard, or come up with a relevant search query on his or her own. In this way, techniques of this disclosure may reduce the amount of time and the number of user inputs required to obtain relevant search results, which may simplify the user experience and may reduce power consumption of the computing device.

In one example, a method includes outputting, by an application executing at a computing device, for display, a graphical keyboard comprising a plurality of keys. The method further includes determining, by an application extension of the application, based on contextual information associated with the computing device, a subset of one or more search queries from a predetermined set of two or more search queries. The method further includes outputting, by the application extension, for display, in place of at least a portion of the graphical keyboard, a respective graphical element associated with each search query from the subset of one or more search queries. The method further includes receiving, by the application extension, an indication of user input that selects the respective graphical element associated with a particular search query from the subset of one or more search queries. The method further includes executing, based. on the particular search query, a search and outputting, by the application extension, for display, in place of at least the portion of the graphical keyboard, a graphical indication of one or more search results determined from the search.

In another example, a mobile device includes a presence-sensitive display component, at least one processor, and a memory that stores instructions associated with an application. When executed, the instructions cause the at least one processor to output, for display at the presence-sensitive display component, a graphical keyboard comprising a plurality of keys. The instructions further cause the at least one processor to determine, by an application extension of the application, based on contextual information associated. with the computing device, a subset of one or more search queries from a predetermined set of two or more search queries. The instructions further cause the at least one processor to output, by the application extension, for display at the presence-sensitive display component, in place of at least a portion of the graphical keyboard, a respective graphical element associated with each search query from the subset of one or more search queries. The instructions further cause the at least one processor to receive, by the application extension and at the presence-sensitive display component, an indication of user input that selects the respective graphical element associated with a particular search query from the subset of one or more search queries. The instructions further cause the at least one processor to execute, based on the particular search query, a search and output, by the application extension, for display at the presence-sensitive display component, in place of at least the portion of the graphical keyboard, a graphical indication of one or more search results determined from the search.

In another example, a non-transitory computer-readable storage medium storing instructions associated with an application that, when executed, cause at least one processor of a computing device to output, for display, a graphical keyboard comprising a plurality of keys. The instructions further cause the at least one processor to determine, by an application extension of the application, based on contextual information associated with the computing device, a subset of one or more search queries from a predetermined set of two or more search queries. The instructions further cause the at least one processor to output, by the application extension, for display at the presence-sensitive display component, in place of at least a portion of the graphical keyboard, a respective graphical element associated with each search query from the subset of one or more search queries. The instructions further cause the at least one processor to receive, by the application extension and at the presence-sensitive display component, an indication of user input that selects the respective graphical element associated with a particular search query from the subset of one or more search queries. The instructions further cause the at least one processor to execute, based on the particular search query, a search and output, by the application extension, for display at the presence-sensitive display component, in place of at least the portion of the graphical keyboard, a graphical indication of one or more search results determined from the search.

in another example, an apparatus includes means for outputting, by an application, for display, a graphical keyboard comprising a plurality of keys. The apparatus further includes means for determining, by an application extension of the application, based on contextual information associated with the computing device, a subset of one or more search queries from a predetermined set of two or more search queries. The apparatus further includes means for outputting, by the application extension, for display, in place of at least a portion of the graphical keyboard, a respective graphical element associated with each search query from the subset of one or more search queries. The apparatus further includes means for receiving, by the application extension, an indication of user input that selects the respective graphical element associated with a particular search query from the subset of one or more search queries. The apparatus further includes means for executing, based on the particular search query, a search and means for outputting, by the application extension, for display, in place of at least the portion of the graphical keyboard, a graphical indication of one or more search results determined from the search.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example computing device that executes an application extension that is configured to dynamically determine a subset of predetermined search queries, in accordance with one or more aspects of the present disclosure.

FIG. 2 is a block diagram illustrating an example computing device that executes an application extension that is configured to dynamically determine a subset of predetermined search queries, in accordance with one or more aspects of the present disclosure.

FIG. 3 is a block diagram illustrating an example computing device that outputs graphical content for display at a remote device, in accordance with one or more techniques of the present disclosure.

FIGS. 4A-4C are conceptual diagrams illustrating example graphical user interfaces of an example computing device that executes an application extension that is configured to dynamically determine a subset of predetermined search queries, in accordance with one or more aspects of the present disclosure.

FIG. 5 is a flowchart illustrating example operations of a computing device that executes an application extension that is configured to dynamically determine a subset of predetermined search queries, in accordance with one or more aspects of the present disclosure.

### DETAILED DESCRIPTION

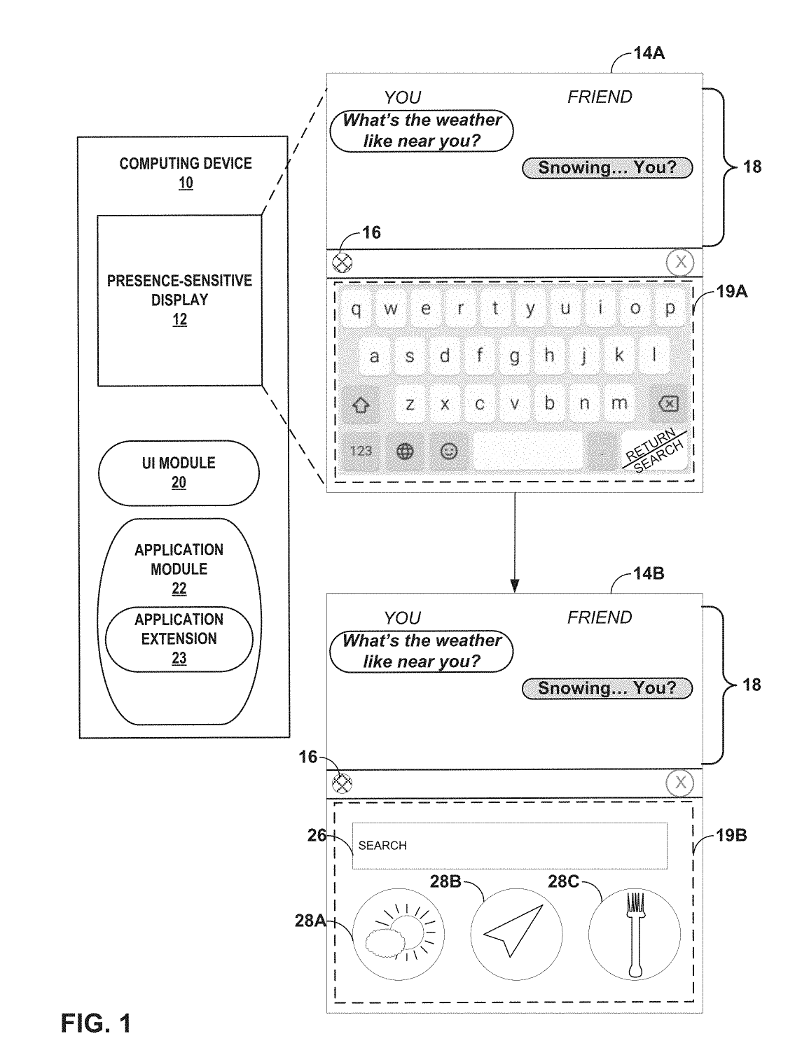

FIG. 1 is a conceptual diagram illustrating an example computing device 10 that executes application extension 23 that is configured to dynamically determine a subset of predetermined search queries, in accordance with one or more aspects of the present disclosure. Computing device 10 may represent a mobile device, such as a smart phone, a tablet computer, a laptop computer, computerized watch, computerized eyewear, computerized gloves, or any other type of portable computing device. Additional examples of computing device 10 include desktop computers, televisions, personal digital assistants (FDA), portable gaming systems, media players, e-book readers, mobile television platforms, automobile navigation and entertainment systems, vehicle (e.g., automobile, aircraft, or other vehicle) cockpit displays, or any other types of wearable and non-wearable, mobile or non-mobile computing devices that may output a graphical keyboard for display.

Computing device 10 includes a presence-sensitive display (PSD) 12, user interface (UI) module 20 and application module 22. Application module 22 includes application extension module 23 (referred to simply as “application extension 23”). Modules 20, 22 and 23 may perform operations described using software, hardware, firmware, or a mixture of hardware, software, and firmware residing in and/or executing at computing device 10. One or more processors of computing device 10 may execute instructions that are stored at a memory or other non-transitory storage medium of computing device 10 to perform the operations of modules 20 and 22. Computing device 10 may execute modules 20, 22 and 23 as virtual machines executing on underlying hardware. Modules 20, 22, and 23 may execute as one or more services of an operating system or computing platform. Modules 20, 22 and 23 may execute as one or more executable programs at an application layer of a computing platform. Application extension 23 may be an additional application installed at computing device 10 and executable through application module 22. In some instances, such as the example of FIG. 1. application extension 23 may be an add-on or part of application module 22. In other instances, application extension 23 may be a separate application that is executable by computing device 10 during the execution of application module 22.

PSD 12 of computing device 10 may function as respective input and/or output devices for computing device 10. PSD 12 may be implemented using various technologies. For instance, PSD 12 may function as input devices using presence-sensitive input screens, such as resistive touchscreens, surface acoustic wave touchscreens, capacitive touchscreens, projective capacitance touchscreens, pressure sensitive screens, acoustic pulse recognition touchscreens, or another presence-sensitive display technology. PSD 12 may also function as output (e.g., display) devices using any one or more display devices, such as liquid crystal displays (LCD), dot matrix displays, light emitting diode (LED) displays, organic light-emitting diode (OLED) displays, e-ink, or similar monochrome or color displays capable of outputting visible information to a user of computing device 10.

PSD 12 may detect input (e.g., touch and non-touch input) from a user of respective computing device 10. PSD 12 may detect indications of input by detecting one or more gestures from a user (e.g., the user touching, pointing, and/or swiping at or near one or more locations of PSD 12 with a finger or a stylus pen). PSD 12 may output information to a user in the form of a user interface (e.g., user interfaces 14A and/or 14B), which may be associated with functionality provided by computing device 10. Such user interfaces may be associated with computing platforms, operating systems, applications, and/or services executing at or accessible from computing device 10 (e.g., electronic message applications, chat applications, Internet browser applications, mobile or desktop operating systems, social media applications, electronic games, and other types of applications). For example, PSD 12 may present user interfaces 14A and 14B which, as shown in FIG. 1, are graphical user interfaces of a chat application executing at computing device 10 and includes various graphical elements displayed at various locations of PSD 12.

As shown in FIG. 1, user interface 144 is a chat user interface. However, user interface 144 may be any graphical user interface which includes a graphical keyboard with integrated search features. User interface 14A includes output region 18, graphical keyboard 19A, and search key 16. A user of computing device 10 may provide input at graphical keyboard 194 to produce textual characters within an edit region that forms the content of the electronic messages displayed within output region 18. The messages displayed within output region 18 form a chat conversation between a user of computing device 10 and a user of a different computing device.

UI module 20 manages user interactions with PSD 12 and other components of computing device 10. In other words, UI module 20 may act as an intermediary between various components of computing device 10 to make determinations based on user input detected by PSD 12 and generate output at PSD 12 in response to the user input. UI module 20 may receive instructions from an application, service, platform, or other module of computing device 10 to cause PSD 12 to output a user interface (e.g., user interface 14A). UI module 20 may manage inputs received by computing device 10 as a user views and interacts with the user interface presented at PSD 12 and update the user interface in response to receiving additional instructions from the application, service, platform, or other module of computing device 10 that is processing the user input.

Application module 22 represents an application, service, or component executing at or accessible to computing device 10 that provides computing device 10 with a graphical keyboard that, when application extension 23 is further installed on computing device 10, also has integrated search features including search query prediction and execution. For instance, application module 22 may be a messaging application, a chat application, or any other application that may utilize a graphical keyboard as part of its functionality. Application module 22 may switch between operating in text-entry mode in which application module 22 includes functions similar to a traditional graphical keyboard, or search mode in which computing device 10 further executes application extension 23 to determine a subset of search queries from a set of predetermined search queries based on contextual information associated with computing device 10 or application module 22 itself and performs various integrated search functions, image based search functions, or interfaces with one or more search and image based search applications or functionality.

In some examples, computing device 10 may download application extension 23 from an application-extension distribution platform. In such examples, prior to executing any of the techniques described herein, application module 22 may install application extension 23 to computing device 10 and application module 22.

In some examples, application module 22 may be a stand-alone application, service, or module executing at computing device 10 and, in other examples, application module 22 may be a sub-component acting as a service for other applications or device functionality. For example, application module 22 may be integrated into a chat or messaging application executing at computing device 10 whereas, in other examples, application module 22 may be a stand-alone application or subroutine that is invoked by an application or operating platform of computing device 10 any time an application or operating platform requires graphical keyboard input functionality. In some examples, computing device 10 may download and install application module 22 from an application distribution platform, such as an application repository of a service provider (e.g., via the Internet). In other examples, application module 22 may be preloaded during production of computing device 10 or installation of an operating system of computing device 10.

When operating in text-entry mode, application module 22 of computing device 10 may utilize graphical keyboard 19A to perform traditional, graphical keyboard operations used for text-entry, such as: generating a graphical keyboard layout for display at PSD 12, mapping detected inputs at PSD 12 to selections of graphical keys, determining characters based on selected keys, or predicting or autocorrecting words and/or phrases based on the characters determined from selected keys.

Graphical keyboard 19A includes graphical elements displayed as graphical keys. Application module 22 may output information to UI module 20 that specifies the layout of graphical keyboard 19A within user interface 14. For example, the information may include instructions that specify locations, sizes, colors, and other characteristics of the various graphical keys. Based on the information received from application module 22, UI module 20 may cause PSD 12 to display graphical keyboard 19A as part of user interface 14.

Each key of the graphical keys of graphical keyboard 19A may be associated with one or more respective characters (e.g., a letter, number, punctuation, or other character) displayed within the key. A user of computing device 10 may provide input at locations of PSD 12 at which one or more of the graphical keys are displayed to input content (e.g., characters, search results, etc.) into an edit region (e.g., for composing messages that are sent and displayed within output region 18 or for inputting an image based search query that computing device 10 executes from within graphical keyboard 19A). Application module 22 may receive information from UI module 20 indicating locations associated with input detected by PSD 12 that are relative to the locations of each of the graphical keys. Using a spatial and/or language model, application module 22 may translate the inputs to selections of keys and characters, words, and/or phrases.

During execution of application module 22. computing device 10 may output graphical keyboard 19A for display at PSD 12. Application module 22 may be stored in a memory of computing device 10 as executable code that implements various functionalities of graphical keyboard 19A. In some instances, application extension 23 may also be stored in the memory of computing device 10 as executable code that is executable by modules 20 and 22. In some instances, application extension 23 may be a sub-application within application module 22 that when executed, configured application module 22 to provide additional functionality, such as search functionality, to application module 22. In other instances, application extension 23 may be a separate application from application module 22.

In general, application extension 23 may be any executable application extension having functionality that is accessible, to a user, from within graphical keyboard 19A to provide additional functionality to graphical keyboard 19A. For example, PSD 12 may detect user inputs as a user of computing device 10 provides the user inputs (e.g., as the user gestures) at or near a location of PSD 12 where PSD 12 presents graphical keyboard 19A. The user may provide tap or non-tap (e.g., continuous swipe) gestures at PSD 12 to type at graphical keyboard 19A to enter the phrase ‘What's the weather like near you?’ at the edit region. UI module 20 may receive, from PSD 12, an indication of the user input detected by PSD 12 and output, to application module 22, information about the user input. Information about the user input may include an indication of one or more touch events (e.g., locations and other information about the input) detected by PSD 12.

Based on the information received from UI module 20, application module 22 may map detected inputs at PSD 12 to selections of some graphical keys of graphical keyboard 19A, determine characters based on the selected keys, and predict or autocorrect words and/or phrases determined based on the characters associated with the selected keys. For example, application module 22 may include a spatial model that may determine, based on the locations of the selected keys and the information about the input, the most likely one or more keys being selected are the keys. Responsive to determining the most likely one or more keys being selected, application module 22 may determine one or more characters, words, and/or phrases. For example, each of the one or more keys being selected from a user input at PSD 12 may represent an individual character or a keyboard operation. Application module 22 may determine a sequence of characters selected based on the one or more selected keys. In some examples, application module 22 may apply a language model to the sequence of characters to determine one or more the most likely candidate letters, morphemes, words, and/or phrases that a user is trying to input based on the selection of keys. In the example of FIG. 1, application module 22 may determine the sequence of characters corresponds to the letters of the phrase ‘What's the weather like near you?’.

Application module 22 may send the sequence of characters and/or candidate words and phrases (e.g., ‘What's the weather like near you?) to UI module 20 and UI module 20 may cause PSD 12 to present the characters and/or candidate words determined from a selection of one or more keys of graphical keyboard 19A as text within the edit region. In some examples, when including a traditional keyboard for performing text-entry operations, and in response to receiving a user input at the graphical keys (e.g., as a user is typing at graphical keyboard 19A to enter text within the edit region), application module 22 may cause UI module 20 to display the candidate words and/or phrases as one or more selectable spelling corrections and/or selectable word or phrase suggestions.

In addition to performing traditional, graphical keyboard operations used for text-entry, application module 22 of computing device 10, with its reliance on application extension 23, also provides integrated search capability. That is, rather than requiring a user of computing device 10 to navigate away from user interface 14 which provides graphical keyboard 19A (e.g., to a different application or service executing at or accessible from computing device 10), application extension 23 enables application module 22 to operate in search mode to execute search operations, such as predicting predetermined search queries based on contextual information associated with computing device 10 or application module 22 (e.g., a user account on application module 22 or a content history of application module 22), and presenting the predicted search queries, such as within the same region of PSD 12 at which graphical keyboard 19A is displayed. For instance, PSD 12 may receive an indication of user input at search key 16 to cause application module 22 to activate application extension 23 and toggle between the standard text-entry mode and the search mode.

As indicated above, application module 22 may execute as a stand-alone application, service, or module executing at computing device 10 or as a single, integrated sub-component thereof. Therefore, if application module 22 forms part of a chat or messaging application executing at computing device 10, application module 22 may provide the chat or messaging application with text-entry capability as well as search capability. Similarly, if application module 22 is a stand-alone application or subroutine that is invoked by an application or operating platform of computing device 10 any time an application or operating platform requires graphical keyboard input functionality, application module 22 may provide the invoking application or operating platform with text-entry capability as well as search capability.

When operating in search mode, application module 22 may execute application extension 23 to perform various search related functions. For example, application extension 23 may perform searches based on predetermined search queries stored on computing device 10, the results of which may be standard Internet searches, image based searches, emoji searches, translations, and other search related features. While application module 22 and application extension 23 may both be displayed in the same place as graphical keyboard 19A, application module 22 and application extension 23 may be completely independent processes with different functions and limitations, and may be distributed separately.

In accordance with the techniques of this disclosure, as described above, UI module 20 may execute application module 22 to initially output, for display at PSD 12, graphical keyboard 19A. In such instances, application module 22 may be initially configured to receive inputs that result in entering text to be included into messages shown in output region 18. While III module 20 is outputting graphical keyboard 19A for display at PSD 12, application module 22 may activate application extension 23 to toggle application module 22 from a text-entry mode into a search mode. In some instances, application module 22 may activate application extension 23 in response to receiving some indication of user input, such as a selection of search key 16. In other instances, application module 22 may automatically activate application extension 23 upon the execution of application module 22.

In the example of FIG. 1, a user of computing device 10 may be exchanging text messages with another user with a second computing device. Computing device 10 may send a first text message to the second computing device that includes the message “What's the weather like near you?” At some later time, computing device 10 may receive a second text message from the second computing device that includes the message “Snowing . . . You?” UI module 20 may output graphical indications of these text messages for display in output region 18.

Prior to collecting contextual information, computing device 10 may prompt a user of computing device 10 for explicit consent to collect the contextual information. The contextual information may include one or more of calendar data, message data, a current time, a current location, a search history, a user account on application module 22, and message recipient data, among other things. For example, prior to retaining contextual information associated with the user of computing device 10 or application module 22, UI module 20 may present a user interface via PSD 12 that requests a user to select a box, click a button, state a voice input, or otherwise provide a specific input to the user interface that is interpreted by computing device 10 as unambiguous, affirmative consent for application extension 23 to collect and make use of the user's personal information and the contextual information. At this point, computing device 10 may continue to execute the remainder of the techniques described herein. For instance, after computing device 10 receives user input indicating that the user consents to the collection of the contextual information about the user and device information describing computing device 10 or a surrounding environment of computing device 10, computing device 10 may proceed to collect said contextual information.

Responsive to being. activated by application module 22, and after receiving explicit consent to do so, application extension 23 may determine, based on contextual information associated with computing device 10 or application module 22, a subset of one or more search queries from a predetermined set of two or more search queries. The predetermined set of search queries may include any pre-loaded or custom-created search queries stored in memory on computing device 10. The search queries may include a recent search query, a query for nearby food and restaurants, a general query for what is near the current location of computing device 10, a query for nearby entertainment, a query for nearby activities, a query for currently trending topics on a social media platform, a query for recent videos, a query for nearby bars, a query for the current weather, a query for current movies being shown in nearby theatres, a query for current scores of sporting events, or any other query, custom or otherwise, that may be of relevance to a user in a text message conversation. Application extension 23 may select one or more of the predetermined search queries based on the previously collected contextual information to complete a subset of one or more search queries.

In the example of FIG. 1, application extension 23 may analyze the message data of the text messages previously exchanged between computing device 10 and the second computing device and a current time to determine the subset of search queries. Application extension 23 may determine that both of the text messages exchanged between computing device 10 and the second computing device include comments regarding the weather, including a question from the second computing device regarding the current weather near computing device 10. As such, one of the selected search queries from the predetermined set may be a query for the current weather. Application extension 23 may further determine that one of the text messages sent by the user contains the words “near you.” As such, another selected search query from the predetermined set may be a general query for what is near the current location of computing device 10. Finally, a current time may be around a time at which the user of computing device 10 typically eats dinner. As such, a third selected search query from the predetermined set may be a query for nearby food and restaurants.

Responsive to application extension 23 determining the subset of search queries, application extension 23 may output. via UI module 20, for display in PSD 12, a respective graphical element 28A-28C associated with each search query from the subset of one or more search queries in place of at least a portion of graphical keyboard 19A. For instance, in the example of FIG. 1, application extension 23 determined the subset of search queries to be a query for the current weather, a general query for what is near the current location of computing device 10, and a query for nearby food and restaurants. Application extension 23 may utilize UI module 20 to output graphical interface 14B that replaces graphical keyboard 19A with search interface 19B, which may include custom search bar 26 and graphical elements 28A-28C. In some instances, UI module 20 may not include custom search bar 26 in the outputted search interface, instead including only graphical elements 28A-28C. In the example of FIG. 1, graphical element 28A may be associated with the query for the current weather, graphical element 28B may be associated with the general query or what is near the current location of computing device 10, and graphical element 28C may be associated with the query for nearby food and restaurants.

From user interface 14B, computing device 10 may execute a search based on a search query from the subset of one or more search queries. For instance, computing device 10 may receive an indication of user input that selects a respective graphical element of graphical elements 28A-28C associated with a particular search query from the subset of one or more search queries. Computing device 10 may execute a search based on the particular search query and output, for display on PSD 12, a graphical indication of one or more search results determined from the executed search in place of at least the portion of graphical keyboard 19A. In some instances, application extension 23 of computing device 10 may perform the search. In other instances, a different search application may ultimately perform the search, such as application module 22, a search application executing at computing device 10, or a search application that is executing at a remote computing device (e.g., a server) and accessible to computing device 10 (e.g., via a network connection).

For example, application extension 23 may receive an indication of user input selecting graphical element 28A, which is associated with the query for the current weather. Responsive to receiving this selection, application extension 23 may execute the search query for the current weather, either via a web search for the current weather or by retrieving data stored on computing device 10 that defines the current weather. In executing the search query, application module 22 may retrieve one or more search results for the current weather from the Internet or computing device 10. The search results could include a webpage having a current forecast, or a graphical card that includes temperature and precipitation information. Responsive to receiving these search results, application extension 23 may utilize UI module 20 to output a respective graphical indication for each of the one or more search results for display on PSD 12, such as in the place of graphical keyboard 19A and search interface 19B.

In some instances, application extension 23 may receive another indication of user input selecting one of the graphical indications for a particular search result. Responsive to this selection, computing device 10 may send a message to the second computing device that includes the particular search result, enabling computing device 10 to efficiently share content with other computing devices without having to switch applications or provide extraneous input. In this way, techniques of this disclosure may reduce the amount of time and the number of user inputs required to obtain and distribute relevant search results, which may simplify the user experience and may reduce power consumption of computing device 10.

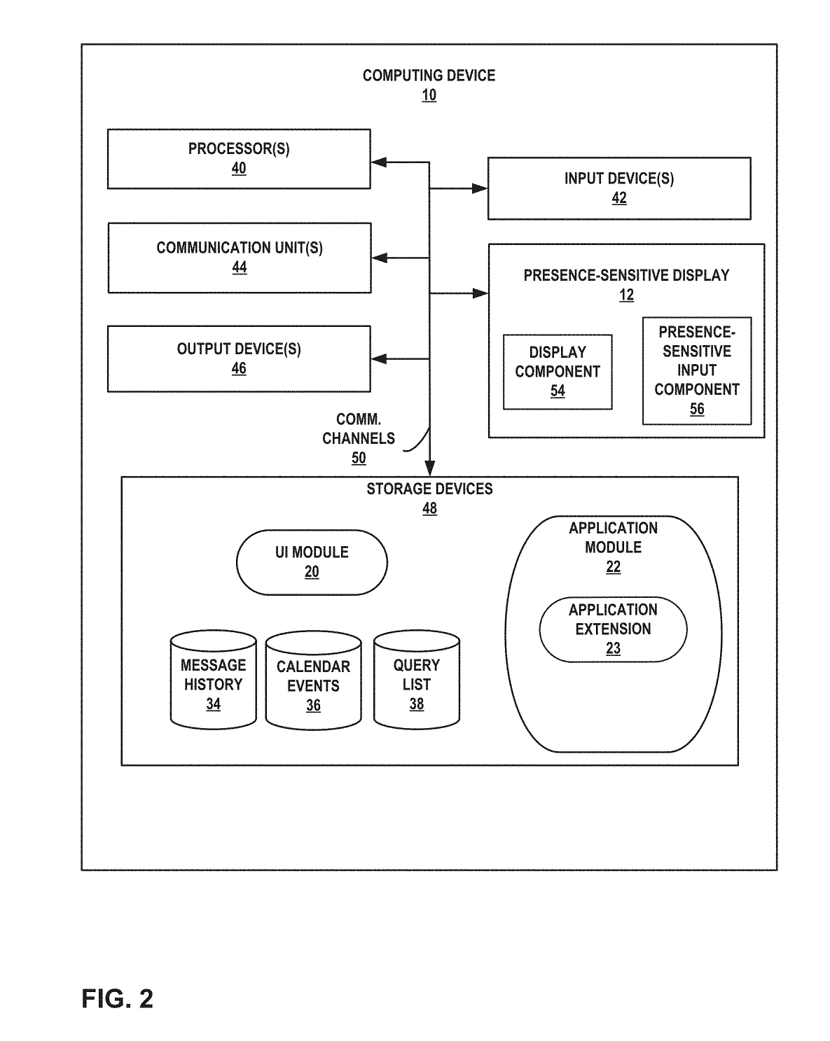

FIG. 2 is a block diagram illustrating an example computing device 10 that executes an application extension that is configured to dynamically determine a subset of predetermined search queries, in accordance with one or more aspects of the present disclosure. Computing device 10 of FIG. 2 is described below as an example of computing device 10 of FIG. 1. FIG. 2 illustrates only one particular example of computing device 10, and many other examples of computing device 10 may be used in other instances and may include a subset of the components included in example computing device 10 or may include additional components not shown in FIG. 2.

As shown in the example of FIG. 2, computing device 10 includes PSD 12, one or more processors 40, one or more input components 42, one or more communication units 44, one or more output components 46, and one or more storage devices 48. Presence-sensitive display 12 includes display component 54 and presence-sensitive input component 56. Storage devices 48 of computing device 10 include UI module 20 and application module 22. Application module 22 may include context module 30 and query module 32. Storage devices 48 also includes message history 34, calendar events 36, and query list 38. Communication channels 50 may interconnect each of the components 12, 40, 44, 42, 46, and 48 for inter-component communications (physically, communicatively, and/or operatively). In some examples, communication channels 50 may include a system bus, a network connection, an inter-process communication data structure, or any other method for communicating data.

One or more communication units 44 of computing device 10 may communicate with external devices via one or more wired and/or wireless networks by transmitting and/or receiving network signals on the one or more networks. Examples of communication units 44 include a network interface card (e.g. such as an Ethernet card), an optical transceiver, a radio frequency transceiver, a GPS receiver, or any other type of device that can send and/or receive information. Other examples of communication units 44 may include short wave radios, cellular data radios, wireless network radios, as well as universal serial bus (USB) controllers.

One or more input components 42 of computing device 10 may receive input. Examples of input are tactile, audio, and video input. Input components 42 of computing device 10, in one example, includes a presence-sensitive input device (e.g., a touch sensitive screen, a PSD), mouse, keyboard, voice responsive system, video camera, microphone or any other type of device for detecting input from a human or machine. In some examples, input components 42 may include one or more sensor components one or more location sensors (GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., microphone, camera, infrared proximity sensor, hygrometer, and the like). Other sensors may include a heart rate sensor, magnetometer, glucose sensor, hygrometer sensor, olfactory sensor, compass sensor, step counter sensor, to name a few other non-limiting examples.

One or more output components 46 of computing device 10 may generate output. Examples of output are tactile, audio, and video output. Output components 46 of computing device 10, in one example, includes a PSD, sound card, video graphics adapter card, speaker, cathode ray tube (CRT) monitor, liquid crystal display (LCD), or any other type of device for generating output to a human or machine.

PSD 12 of computing device 10 may be similar to PSD 12 of computing device 10 and includes display component 54 and presence-sensitive input component 56. Display component 54 may be a screen at which information is displayed by PSD 12 and presence-sensitive input component 56 may detect an object at and/or near display component 54. As one example range, presence-sensitive input component 56 may detect an object, such as a finger or stylus that is within two inches or less of display component 54. Presence-sensitive input component 56 may determine a location (e.g., an [x, y] coordinate) of display component 54 at which the object was detected. In another example range, presence-sensitive input component 56 may detect an object six inches or less from display component 54 and other ranges are also possible. Presence-sensitive input component 56 may determine the location of display component 54 selected by a user's finger using capacitive, inductive, and/or optical recognition techniques. In some examples, presence-sensitive input component 56 also provides output to a user using tactile, audio, or video stimuli as described with respect to display component 54, in the example of FIG. 2, PSD 12 may present a user interface (such as graphical user interfaces 14A and 14B of FIG. 1).

While illustrated as an internal component of computing device 10, PSD 12 may also represent an external component that shares a data path with computing device 10 for transmitting and/or receiving input and output. For instance, in one example, PSD 12 represents a built-in component of computing device 10 located within and physically connected to the external packaging of computing device 10 (e.g., a screen on a mobile phone). In another example, PSD 12 represents an external component of computing device 10 located outside and physically separated from the packaging or housing of computing device 10 (e.g., a monitor, a projector, etc. that shares a wired and/or wireless data path with computing device 10).

PSD 12 of computing device 10 may detect two-dimensional and/or three-dimensional gestures as input from a user of computing device 10. For instance, a sensor of PSD 12 may detect a user's movement (e.g., moving a hand, an arm, a pen, a stylus, etc.) within a threshold distance of the sensor of PSD 12. PSD 12 may determine a two or three-dimensional vector representation of the movement and correlate the vector representation to a gesture input (e.g., a hand-wave, a pinch, a clap, a pen stroke, etc.) that has multiple dimensions. In other words, PSD 12 can detect a multi-dimension gesture without requiring the user to gesture at or near a screen or surface at which PSD 12 outputs information for display. Instead, PSD 12 can detect a multi-dimensional gesture performed at or near a sensor which may or may not be located near the screen or surface at which PSD 12 outputs information for display.

One or more processors 40 may implement functionality and/or execute instructions associated with computing device 10. Examples of processors 40 include application processors, display controllers, auxiliary processors, one or more sensor hubs, and any other hardware configure to function as a processor, a processing unit, or a processing device. Modules/applications 20, 22, and 23 may be operable by processors 40 to perform various actions, operations, or functions of computing device 10. For example, processors 40 of computing device 10 may retrieve and execute instructions stored by storage devices 48 that cause processors 40 to perform the operations of modules/applications 20, 22, and 23. The instructions, when executed by processors 40, may cause computing device 10 to store information within storage devices 48.

One or more storage devices 48 within computing device 10 may store information for processing during operation of computing device 10 (e.g., computing device 10 may store data accessed by modules/applications 20, 22, and 23, and data stores 34. 36, and 38 during execution at computing device 10). In some examples, storage device 48 is a temporary memory, meaning that a primary purpose of storage device 48 is not long-term storage. Storage devices 48 on computing device 10 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage devices 48, in some examples, also include one or more computer-readable storage media. Storage devices 48 in some examples include one or more non-transitory computer-readable storage mediums. Storage devices 48 may be configured to store larger amounts of information than typically stored by volatile memory. Storage devices 48 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage devices 48 may store program instructions and/or information (e.g., data) associated with modules/applications 20, 22, and 23, and data stores 34, 36, and 38. Storage devices 48 may include a memory configured to store data or other information associated with modules/applications 20, 22, and 23, and data stores 34, 36, and 38.

UI module 20 may include all functionality of UI module 20 of computing device 10 of FIG. I and may perform similar operations as UI module 20 for managing a user interface (e.g., user interface 14) that computing device 10 provides at presence-sensitive display 12 for handling input from a user. For example, UI module 20 of computing device 10 may query application module 22 for a keyboard layout (e.g., an English language QWERTY keyboard, etc.). UI module 20 may transmit a request for a keyboard layout over communication channels 50 to application module 22. Application module 22 may receive the request and reply to UI module 20 with data associated with the keyboard layout. UI module 20 may receive the keyboard layout data over communication channels 50 and use the data to generate a user interface. UI module 20 may transmit a display command and data over communication channels 50 to cause PSD 12 to present the user interface at PSD 12.

In some examples, UI module 20 may receive an indication of one or more user inputs detected at PSD 12 and may output information about the user inputs to application module 22. For example, PSD 12 may detect a user input and send data about the user input to UI module 20. UI module 20 may generate one or more touch events based on the detected input. A touch event may include information that characterizes user input, such as a location component (e.g., [x,y] coordinates) of the user input, a time component (e.g., when the user input was received), a force component (e.g., an amount of pressure applied by the user input), or other data (e.g., speed, acceleration, direction, density, etc.) about the user input.

Based on location information of the touch events generated from the user input, UI module 20 may determine that the detected user input is associated the graphical keyboard. module 2.0 may send an indication of the one or more touch events to application module 22 for further interpretation. Application module 22 may determine, based on the touch events received from UI module 20, that the detected user input represents an initial selection of one or more keys of the graphical key board.

Application module 22 may include all functionality of application module 22 of computing device 10 of FIG. I and may perform similar operations as application module 22 for providing a graphical keyboard having integrated search features. Application module 22 may include various submodules, such as application extension 23, which may perform the search functionality of application module 22.

Message history 34 may be a data store containing data associated with messages sent between a user of computing device 10 and a user of a second computing device. In some instances, message history 34 may include data associated with messages sent between a user of computing device 10 and multiple other users of multiple other respective computing devices. The data associated with the messages could include message timing, message content, message frequency, message response times, and other information associated with messages.

Calendar events 36 may be a data store containing data associated with a calendar application executing on computing device 10. In some instances, the data associated with the calendar application includes indications of event start times, indications of event end times, locations of events, and a description of the event. Although shown in FIG. 2 as a data store in storage devices 48 on computing device 10, in some other examples, calendar events 36 may be cloud data stored on a network calendar service accessible by computing device 10 via communication units 44.

Query list 38 may be a data store containing one or more predefined search queries that application extension 23 may execute, in accordance with the techniques of this disclosure. Examples of queries stored in query list 38 may include a recent search query, a query for nearby food and restaurants, a general query for what is near the current location of computing device 10, a query for nearby entertainment, a query for nearby activities, a query for currently trending topics on a social media platform, a query for recent videos, a query for nearby bars, a query for the current weather, a query for current movies being shown in nearby theatres, a query for current scores of sporting events, or any other query, custom or otherwise, that may be of relevance to a user in a text message conversation. In some instances, these queries may be predetermined and/or preselected by a user of computing device 10 for inclusion in a predetermined set of two or more search queries. A user of computing device 10 may also draft custom queries for inclusion in query list 38 and the predetermined set of two or more search queries.

In accordance with the techniques of this disclosure, UI module 20 may execute application module 22 to initially output, for display at PSD 12, a graphical keyboard. In such instances, application module 22 may be initially configured to receive inputs that result in entering text to be included into messages shown in an output region of PSD 12 and stored in message history 34. While UI module 20 is outputting the graphical keyboard for display at PSD 12, application module 22 may activate application extension 23 to toggle application module 22 from a text-entry mode into a search mode. In some instances, application module 22 may activate application extension 23 in response to receiving some indication of user input, such as a selection of a search key included in the graphical keyboard. In other instances, application module 22 may automatically activate application extension 23 upon the execution of application module 22.

In the example of FIG, 2, a user of computing device 10 may be exchanging text messages with another user with a second computing device. Computing device 10 may send a first text message to the second computing device that includes the message “Did you see what's going viral?” At some later time, computing device 10 may receive a second text message from the second computing device that includes the message “No, I've been in meetings all day. What's up?” UI module 20 may output graphical indications of these text messages for display in an output region of PSD 12.

Prior to collecting contextual information, computing device 10 may prompt a user of computing device 10 for explicit consent to collect the contextual information. The contextual information may include one or more of calendar data in calendar events 36, message data in message history 34, a current time, a current location, a search history a search history associated with a user of the computing device, a user account associated with application module 22, a crowdsourced search history associated with users of other computing devices, and message recipient data in message history 34, among other things. For example, prior to retaining contextual information associated with the user of computing device 10, UI module 20 may present a user interface via PSD 12 that requests a user to select a box, click a button, state a voice input, or otherwise provide a specific input to the user interface that is interpreted by computing device 10 as unambiguous, affirmative consent for application extension 23 to collect and make use of the user's personal information and the contextual information. At this point, computing device 10 may continue to execute the remainder of the techniques described herein. For instance, after computing device 10 receives user input indicating that the user consents to the collection of the contextual information about the user and device information describing computing device 10 or a surrounding environment of computing device 10, computing device 10 may proceed to collect said contextual information.

Responsive to being activated by application module 22, and after receiving explicit consent to do so, application extension 23 may determine, based on contextual information associated with computing device 10 or application module 22, a subset of one or more search queries from a predetermined set of two or more search queries. The predetermined set of search queries may include any pre-loaded or custom-created search queries stored in query list 38 on computing device 10. The query list 38 may include a recent search query, a query for nearby food and restaurants, a general query for what is near the current location of computing device 10. a query for nearby entertainment, a query for nearby activities, a query for currently trending topics on a social media platform, a query for recent videos, a query for nearby bars, a query for the current weather, a query for current movies being shown in nearby theatres, a query for recent news articles, a query for current scores of sporting events, or any other query, custom or otherwise, that may be of relevance to a user in a text message conversation. Application extension 23 may select one or more of the predetermined search queries based on the previously collected contextual information to complete a subset of one or more search queries.

In the example of FIG. 2, to determine the subset of search queries, application extension 23 may analyze the message data of the text messages previously exchanged between computing device 10 and the second computing device in message history 34, a current location of computing device 10, and a current time. In other words, a machine learning or other artificial intelligence system of application extension 23 may take as inputs, message data, location data, and time data, and in response, output a set of search queries related to the message data, location data and time data.

Application extension 23 may determine that text message conversation between computing device 10 and the second computing device began with a general question regarding a “viral” topic, which is a slang term for a news item that is being spread over a social media platform at a great rate. In response to identifying “viral” as a topic of conversation, application extension module 23 may determine that one of the selected search queries from the predetermined set may be a query for “currently trending topics” (e.g., on a social media platform) with a focus on computing device 10's current location at the current time. Another selected search query from the predetermined set may be a recent search query, as the viral topic may have been a topic that computing device 10 has recently searched for. Finally, application extension 23 may determine that the text message conversation included the phrase “meetings all day”. As such, application extension 23 may determine that a third selected search query from the predetermined set may be a custom query for calendar events from calendar events 36.

In some instances, application extension 23 may generate a relevancy score for each search query in the predetermined set of two or more search queries. Application extension 23 may then determine the subset of one or more search queries to be the one or more search queries in the predetermined set of two or more search queries that have the highest respective relevancy scores. For example, as described above, the contextual information in the example of FIG. 2 may include the message data of the text messages previously exchanged between computing device 10 and the second computing device in message history 34, a current location, and a current time. The message data includes a conversation about news and meetings. As such, application extension 23 may determine that a query for nearby bars has a low relevancy score, as the message data does not include any conversation about bars. However, application extension 23 may determine that a query for currently trending topics on a social media platform with a focus on computing device 10's current location at the current time has a high relevancy score, as the message data includes recent messages regarding the topic of news and current events. Application extension 23 may repeat this process for each of the search queries in the predetermined set of two or more search queries and determine the subset of search queries to be output for display in PSD 12 are the search queries with the highest relevancy scores, such as the search queries associated with the top relevancy scores (e.g., the top two, three, four, or some other number of search queries).

In some instances, application extension 23 analyzes the search history associated with the user of computing device 10 in determining the subset of one or more queries. For example, while the user of computing device 10 may have sent a message to the user of the second computing device about a “viral” topic, the user of computing device 10 may prefer to search for actual news articles rather than social media posts. As such, application extension 23 may select a query for recent news articles rather than the query for currently trending topics on a social media platform.

Utilizing the search history in such a way enables application extension 23 to incorporate machine learning techniques into the selection of search queries. If application extension 23 receives user input selecting a graphical element associated with a particular search query, application extension 23 may update the search history based on the selection of the particular search query. When application extension 23 is later activated and must select one of two search queries, application extension 23 may utilize the dynamically updated search history to select the search query more often chosen by the user.

Application extension 23 may similarly utilize the crowdsourced search history associated with users of other computing devices to determine queries. For instance, application extension 23 may determine that two search queries have an equal likelihood of being selected based on other contextual information associated with computing device 10. In such instances, application extension 23 may select the search query that is selected by users of other computing devices more often, as indicated by the crowdsourced search history. In other instances, application extension 23 may determine that one search query has a higher likelihood of being selected than a second search query based on other contextual information associated with computing device 10. However, if the crowdsourced search history indicates that the second search query is chosen much more often than the first search query by users of other computing devices, application extension 23 may select the second search query instead of the first search query. Application extension 23 may periodically receive updates to the crowdsourced search history, meaning that application extension 23 may utilize machine learning techniques on a larger scale than the search history associated with only the user of computing device 10.

Responsive to application extension 23 determining the subset of search queries, application extension 23 may output, via UI module 20, for display in PSD 12, a respective graphical element associated with each search query from the subset of one or more search queries in place of at least a portion of the graphical keyboard. For instance, in the example of FIG. 2, application extension 23 determined the subset of search queries to be a query for currently trending topics on a social media platform with a focus on computing device 10's current location at the current time, a recent search query, and a custom query for calendar events. Application extension 23 may utilize UI module 20 to output a graphical interface that replaces the graphical keyboard with a search interface, which may include a custom search bar and the respective graphical elements. In some instances, UI module 20 may not include the custom search bar in the outputted search interface, instead including only the graphical elements.

In the examples where application extension 23 determines the subset of search queries based on relevancy scores, application extension 23 may further determine an order for the one or more search queries in the subset of one or more search queries based on the respective relevancy score for each search query in the subset of one or more search queries. UI module 20 may then output the respective graphical elements associated nth each search query in accordance with the determined order. For instance, in the example of FIG. 2, application extension 23 determined the subset of search queries to be a query for currently trending topics on a social media platform with a focus on computing device 10's current location at the current time, a recent search query, and a custom query for calendar events. The recent message data stored in message history 34 indicates that the most recent conversation is directly related to “viral” topics and current events. As such, application extension 23 may determine that the query for currently trending topics on a social media platform with a focus on computing device 10's current location at the current time has the highest relevancy score, and UI module 20 may output the graphical element associated with this query in a top or left-most position. The recent message data also includes a phrase about meetings. As such, application extension 23 may determine that the custom query for calendar events has the second highest relevancy score, and UI module 20 may output the graphical element associated with this query in a middle position. Finally, the recent message data may only tangentially indicate that a recent search query may be relevant for the user, as the message data does not directly contain messages regarding a recent search query. As such, application extension 23 may determine that the recent search query has the lowest relevancy score of the subset of search queries, and UI module 20 may output the graphical element associated with this query in a bottom or right-most position.

In some instances, each respective graphical element associated with each search query from the subset of one or more search queries has a unique visual characteristic that is indicative of the respective search query. In other words, the particular search query associated with the respective graphical element may be evident from the design of the respective graphical element. For example, in FIG. 2, application extension 23 determined the subset of search queries to be a query for currently trending topics on a social media platform with a focus on computing device 10's current location at the current time, a recent search query, and a custom query for calendar events. A graphical element associated with the query for currently trending topics on the social media platform may include the logo of the social media platform or a newspaper. A graphical element associated with the recent search query may have a clock design. Further, a graphical element associated with the custom query for calendar events may include a picture or design of a daily or monthly calendar page.

From the search interface, computing device 10 may execute a search based on a search query from the subset of one or more search queries. For instance, computing device 10 may receive an indication of user input that selects a respective graphical element associated with a particular search query from the subset of one or more search queries. Computing device 10 may execute a search based on the particular search query and output, for display on PSD 12, a graphical indication of one or more search results determined from the executed search in place of at least the portion of the graphical keyboard. In some instances, application extension 23 of computing device 10 may perform the search. In other instances, a different search application may ultimately perform the search, such as application module 22, a search application executing at computing device 10, or a search application that is executing at a remote computing device (e.g., a server) and accessible to computing device 10 (e.g., via a network connection over communication units 44).

For example, application extension 23 may receive an indication of user input selecting a graphical element associated with the query for currently trending topics on a social media platform with a focus on computing device 10's current location at the current time. Responsive to receiving this selection, application extension 23 may execute the search query for currently trending topics on a social media platform with a focus on computing device 10's current location at the current time via a web search that includes the domain of the social media platform. In executing the search query, application module 22 may retrieve one or more search results currently trending topics on a social media platform with a focus on computing device 10's current location at the current time from the Internet. The search results could include a webpage having a trending news story or a list of posts on the social media platform regarding the trending topic. Responsive to receiving these search results, application extension 23 may utilize UI module 20 to output a respective graphical indication for each of the one or more search results for display on PSD 12, such as in the place of the graphical keyboard and the search interface.

The manner in which UI module 20 displays the graphical indications of the search results on PSD 12 may be dependent on a physical orientation of computing device 10. For instance, UI module 20 may determine whether computing device 10 is in a portrait display mode (i.e., when the vertical length of PSD 12 is greater than the horizontal length of PSD 12) or in a landscape display mode (i.e., when the horizontal length of PSD 12 is greater than the vertical length of PSD 12). If computing device 10 is in the portrait display mode, UI module 20 may output the graphical indications of the one or more search results determined from the search in a vertical orientation (i.e., the results are vertically scrollable). If computing device 10 is in the landscape display mode. UI module 20 may output the graphical indications of the one or more search results determined from the search in a horizontal orientation e., the results are horizontally scrollable in a carousel-type format).

In some instances, application extension 23 may receive another indication of user input selecting one of the graphical indications for a particular search result. Responsive to this selection, computing device 10 may send a message to the second computing device that includes the particular search result, enabling computing device 10 to efficiently share content with other computing devices without having to switch applications or provide extraneous input. In this way, techniques of this disclosure may reduce the amount of time and the number of user inputs required to obtain and distribute relevant search results, which may simplify the user experience and may reduce power consumption of computing device 10.

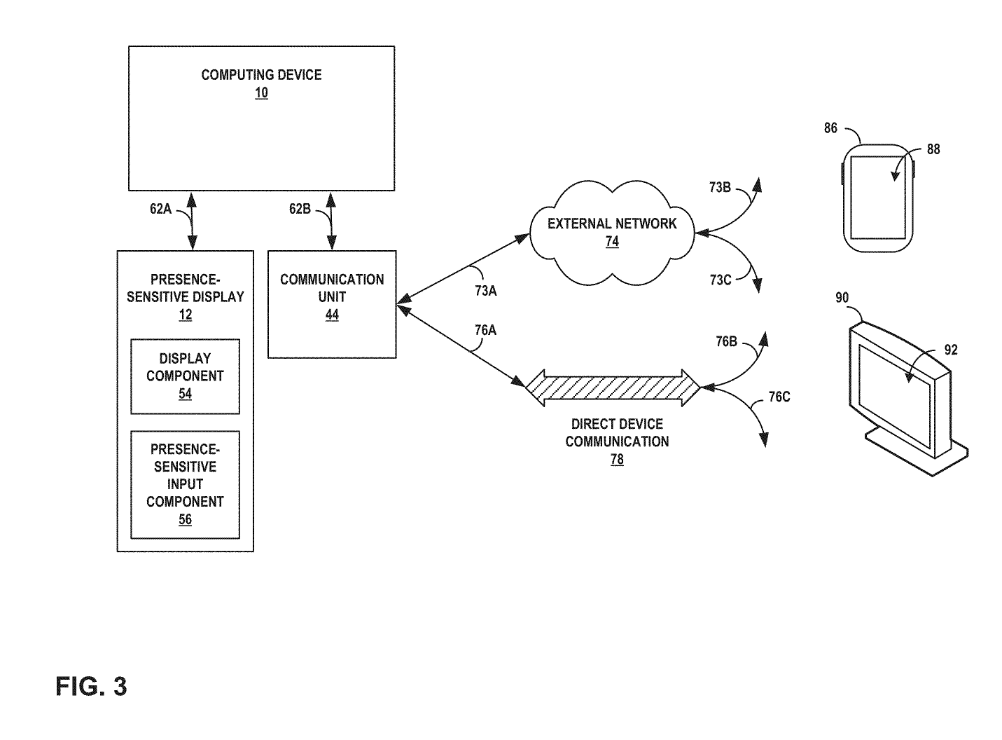

FIG. 3 is a block diagram illustrating an example computing device 10 that outputs graphical content for display at a remote device, in accordance with one or more techniques of the present disclosure. Graphical content, generally, may include any visual information that may be output for display, such as text, images, a group of moving images, to name only a few examples. The example shown in FIG. 3 includes a computing device 10, a PSD 12, communication unit 44, mobile device 86, and visual display component 90. In some examples, PSD 12 may be a presence-sensitive display as described in FIGS. 1-2. Although shown for purposes of example in FIGS. 1 and 2 as a stand-alone computing device 10, a computing device such as computing device 10 may, generally, be any component or system that includes a processor or other suitable computing environment for executing software instructions and, for example, need not include a presence-sensitive display.

As shown in the example of FIG. 3, computing device 10 may be a processor that includes functionality as described with respect to processors 40 in FIG. 2. In such examples, computing device 10 may be operatively coupled to PSD 12 by a communication channel 62A, which may be a system bus or other suitable connection. Computing device 10 may also be operatively coupled to communication unit 44, further described below, by a communication channel 62B, which may also be a system bus or other suitable connection. Although shown separately as an example in FIG. 3, computing device 10 may be operatively coupled to PSD 12 and communication unit 44 by any number of one or more communication channels.

In other examples, such as illustrated previously by computing device 10 in FIGS. 1-2, a computing device may refer to a portable or mobile device such as mobile phones (including smart phones), laptop computers, etc. In some examples, a computing device may be a desktop computer, tablet computer, smart television platform, camera, personal digital assistant (PDA), server, or mainframes.

PSD 12 may include display component 54 and presence-sensitive input component 56. Display component 54 may, for example, receive data from computing device 10 and display the graphical content. In some examples, presence-sensitive input component 56 may determine one or more user inputs (e.g., continuous gestures, multi-touch gestures, single-touch gestures) at PSD 12 using capacitive, inductive, and/or optical recognition techniques and send indications of such user input to computing device 10 using communication channel 62A. In some examples, presence-sensitive input component 56 may be physically positioned on top of display component 54 such that, when a user positions an input unit over a graphical element displayed by display component 54, the location at which presence-sensitive input component 56 corresponds to the location of display component 54 at which the graphical element is displayed.

As shown in FIG. 3, computing device 10 may also include and/or be operatively coupled with communication unit 44. Communication unit 44 may include functionality of communication unit 44 as described in FIG. 2. Examples of communication unit 44 may include a network interface card, an Ethernet card, an optical transceiver, a radio frequency transceiver, or any other type of device that can send and receive information. Other examples of such communication units may include Bluetooth, 3G, and WiFi radios, Universal Serial Bus (USB) interfaces, etc. Computing device 10 may also include and/or be operatively coupled with one or more other devices (e.g., input devices, output components, memory, storage devices) that are not shown in FIG. 3 for purposes of brevity and illustration.

FIG. 3 also illustrates mobile device 86 and visual display component 90. Mobile device 86 and visual display component 90 may each include computing and connectivity capabilities. Examples of mobile device 86 may include e-reader devices, convertible notebook devices, hybrid slate devices, etc. Examples of visual display component 90 may include other devices such as televisions, computer monitors, etc. In some examples, visual display component 90 may be a vehicle cockpit display or navigation display (e.g., in an automobile, aircraft, or some other vehicle). In some examples, visual display component 90 may be a home automation display or some other type of display that is separate from computing device 10.

As shown in FIG. 3, mobile device 86 may include a presence-sensitive display 88. Visual display component 90 may include a presence-sensitive display 92. Presence-sensitive displays 88, 92 may include a subset of functionality or all of the functionality of presence-sensitive display 12, 12, and/or 12 as described in this disclosure. In some examples, presence-sensitive displays 88, 92 may include additional functionality. In any case, presence-sensitive display 92, for example, may receive data from computing device 10 and display the graphical content. In some examples, presence-sensitive display 92 may determine one or more user inputs (e.g., continuous gestures, multi-touch gestures, single-touch gestures) at projector screen using capacitive, inductive, and/or optical recognition techniques and send indications of such user input using one or more communication units to computing device 10.

As described above, in some examples, computing device 10 may output graphical content for display at PSD 12 that is coupled to computing device 10 by a system bus or other suitable communication channel. Computing device 10 may also output graphical content for display at one or more remote devices, such mobile device 86 and visual display component 90. For instance, computing device 10 may execute one or more instructions to generate and/or modify graphical content in accordance with techniques of the present disclosure. Computing device 10 may output the data that includes the graphical content to a communication unit of computing device 10, such as communication unit 44. Communication unit 44 may send the data to one or more of the remote devices, such as mobile device 86 and/or visual display component 90. In this way, computing device 10 may output the graphical content for display at one or more of the remote devices. In some examples, one or more of the remote devices may output the graphical content at a presence-sensitive display that is included in and/or operatively coupled to the respective remote devices.

In some examples, computing device 10 may not output graphical content at PSD 12 that is operatively coupled to computing device 10. In. other examples, computing device 10 may output graphical content for display at both a PSD 12 that is coupled to computing device 10 by communication channel 62A, and at one or more remote devices. In such examples, the graphical content may be displayed substantially contemporaneously at each respective device. In some examples, graphical content generated by computing device 10 and output for display at PSD 12 may be different than graphical content display output for display at one or more remote devices.

Computing device 10 may send and receive data using any suitable communication techniques. For example, computing device 10 may be operatively coupled to external network 74 using network link 73A. Each of the remote devices illustrated in FIG. 3 may be operatively coupled to network external network 74 by one of respective network links 73B, or 73C. External network 74 may include network hubs, network switches, network routers, etc., that are operatively inter-coupled thereby providing for the exchange of information between computing device 10 and the remote devices illustrated in FIG. 3. In some examples, network links 73A-73C may be Ethernet, ATM or other network connections. Such connections may be wireless and/or wired connections.

In some examples, computing device 10 may be operatively coupled to one or more of the remote devices included in FIG. 3 using direct device communication 78. Direct device communication 78 may include communications through which computing device 10 sends and receives data directly with a remote device, using wired or wireless communication. That is, in some examples of direct device communication 78, data sent by computing device 10 may not be forwarded by one or more additional devices before being received at the remote device, and vice-versa. Examples of direct device communication 78 may include Bluetooth, Near-Field Communication, Universal Serial Bus, WiFi, infrared, etc. One or more of the remote devices illustrated in FIG. 3 may be operatively coupled with computing device 10 by communication links 76A-76C. In some examples, communication links 76A-76C may be connections using Bluetooth, Near-Field Communication, Universal Serial Bus, infrared, etc. Such connections may be wireless and/or wired connections.

In accordance with techniques of the disclosure, computing device 10 may be operatively coupled to visual display component 90 using external network 74. Computing device 10 may output a graphical keyboard for display at PSD 92. For instance, computing device 10 may send data that includes a representation of the graphical keyboard to communication unit 44. Communication unit 44 may send the data that includes the representation of the graphical keyboard to visual display component 90 using external network 74. Visual display component 90, in response to receiving the data using external network 74, may cause PSD 92 to output the graphical keyboard.

Computing device 10 may determine, using an application extension of an application executing on computing device 10, based on contextual information associated with the computing device, a subset of one or more search queries from a predetermined set of two or more search queries. Computing device 10 may output, using the application extension, for display at PSD 92, in place of at least a portion of the graphical keyboard, a respective graphical element associated with each search query from the subset of one or more search queries. Computing device 10 may receive, using the application extension, at PSD 92, an indication of user input that selects the respective graphical element associated with a particular search query from the subset of one or more search queries. Computing device 10 may execute, based on the particular search query, a search. Computing device 10 may output, by the application extension, for display at PSD 92, in place of at least the portion of the graphical keyboard, a graphical indication of one or more search results determined from the search.

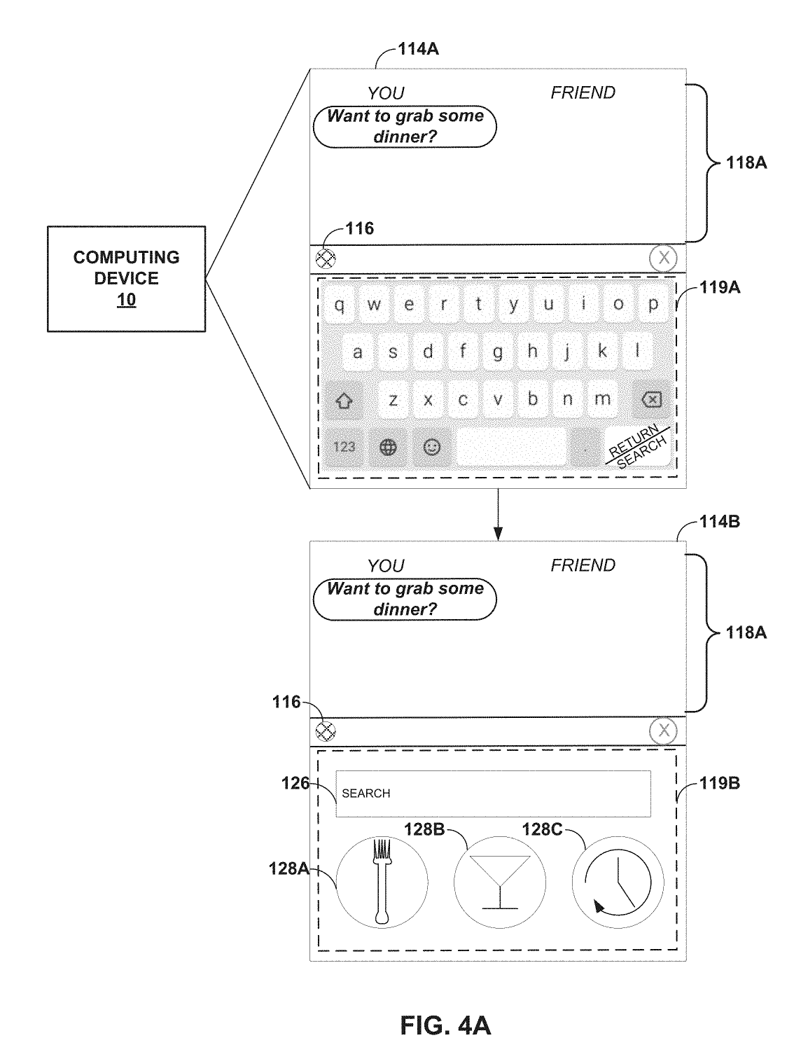

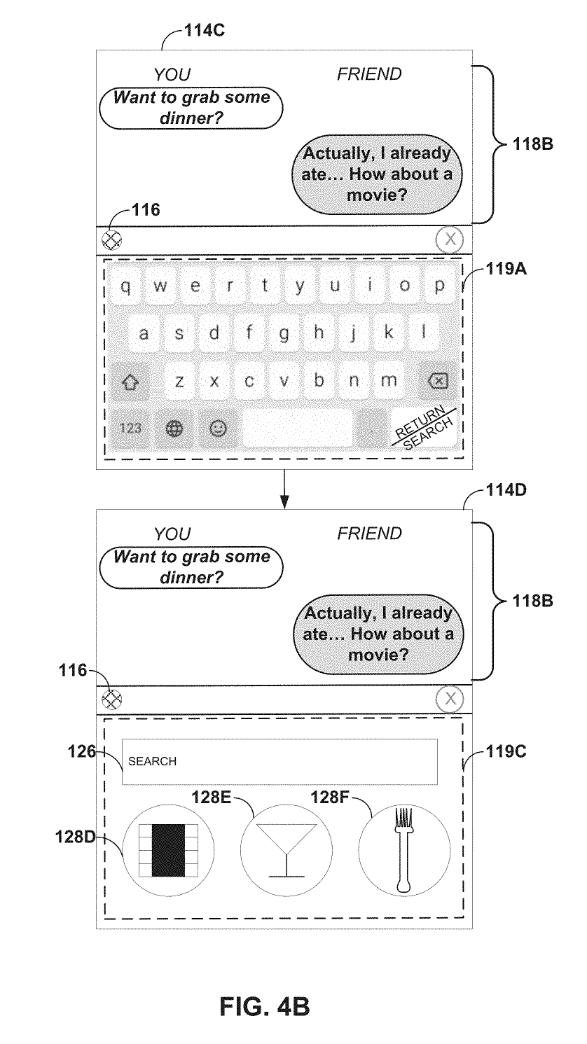

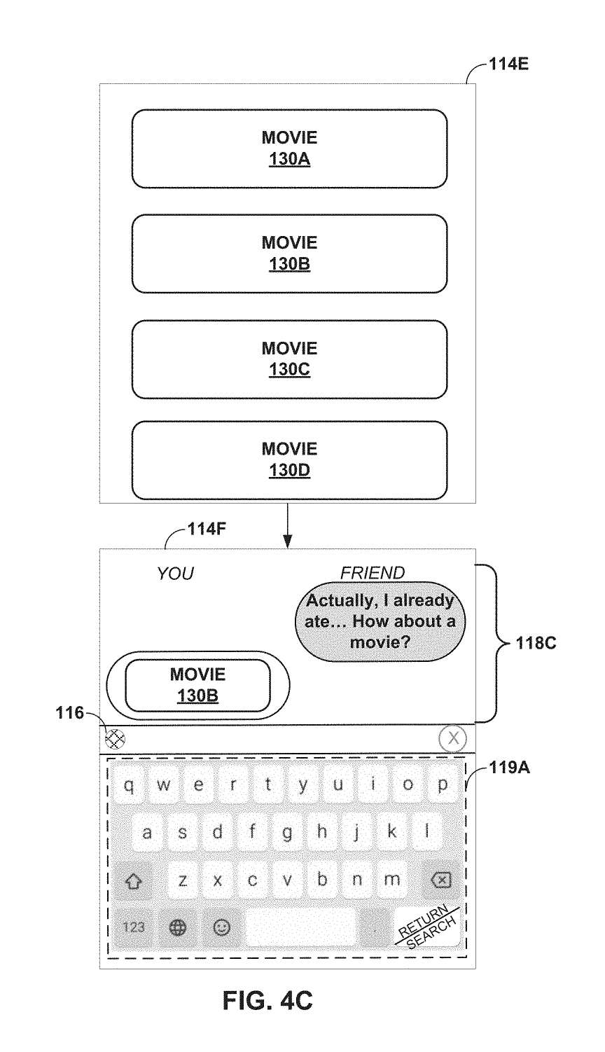

FIGS. 4A-4C are conceptual diagrams illustrating example graphical user interfaces of an example computing device that executes an application extension that is configured to dynamically determine a subset of predetermined search queries, in accordance with one or more aspects of the present disclosure. FIGS. 4A-4C illustrate, respectively, example graphical user interfaces 114A-114F (collectively, user interfaces 114). However, many other examples of graphical user interfaces may be used in other instances. Each of graphical user interfaces 114 may correspond to a graphical user interface displayed by computing device 10 of FIGS. 1 and 2. FIGS. 4A-4F are described below in the context of computing device 10,

Computing device 10 may utilize an application to output graphical user interface 114A. In the example of FIG. 4A, graphical user interface includes output region 118A, search key 116, and graphical keyboard 119A. Output region 118A may include a first text message sent by a user of computing device 10 to a user of a second computing device, with the text message including the message “Want to grab some dinner?”.

At some point after sending the first text message to the user of the second computing device, computing device 10 may receive an indication of user input selecting search key 116, thereby activating an application extension on computing device 10. In response to receiving the indication of user input, computing device 10 may utilize the application extension to output graphical user interface 114B. Graphical user interface 114B may include output region 118A, search key 116, and search interface 119B. In the example of FIG. 4A, search interface 119B further includes custom search bar 126 and graphical elements 128A-128C.

The application extension on computing device 10 may determine a subset of one or more search queries from a predetermined set of two or more search queries based on contextual information associated with the computing device 10. For instance, after receiving explicit consent to do so, the application extension may analyze the message sent by computing device 10 mentioning “dinner”. As such, in accordance with the techniques described herein, the application extension may determine the subset of one or more queries to include a query for nearby food and restaurants, a query for nearby bars, and a recent search query.

Computing device 10 may output graphical elements 128A-128C based on the determined subset of one or more search queries. For instance, computing device 10 may output graphical element 128A, which is associated with the determined query for nearby food and restaurants. Computing device 10 may further output graphical element 128B, which is associated with the determined query for nearby bars. Finally, computing device 10 may output graphical element 128C, which is associated with the determined recent search query.

At a later time, after receiving a subsequent text message from the user of the second computing device, computing device 10 may again utilize the application to output graphical user interface 114C. In the example of FIG. 4B, graphical user interface 114C includes output region 1183, search key 116, and graphical keyboard 119A. Output region 118B may include the first text message sent by a user of computing device 10 to the user of the second computing device, as well as the subsequent text message from the user of the second computing device that reads “Actually, I already ate . . . How about a movie?”.

At some point after receiving the subsequent text message from the user of the second computing device, computing device 10 may receive another indication of user input selecting search key 116, thereby activating the application extension on computing device 10. In response to receiving the indication of user input, computing device 10 may utilize the application extension to output graphical user interface 114D. Graphical user interface 114D may include output region 118B, search key 116, and search interface 1190. In the example of FIG. 4B, search interface 119C further includes custom search bar 126 and graphical elements 128D-128F.

The application extension on computing device 10 may determine an updated subset of one or more search queries from a predetermined set of two or more search queries based on the updated contextual information associated with the computing device 10. For instance, after receiving explicit consent to do so, the application extension may analyze the message sent by computing device 10 mentioning “dinner” and the received message from the user of the second computing device declining dinner and suggesting a movie instead. The application extension can determine that the users are attempting to make plans for the evening. As such, in accordance with the techniques described herein, the application extension may determine the updated subset of one or more queries to include a query for current movies playing in nearby theatres, a query for nearby bars, and a query for nearby food and restaurants.

Computing device 10 may output graphical elements 128D-128F based on the determined subset of one or more search queries. For instance, computing device 10 may output graphical element 128D, which is associated with the determined query for current movies playing in nearby theatres. Computing device 10 may further output graphical element 128E, which is associated with the determined query for nearby bars. Finally, computing device 10 may output graphical element 128D, which is associated with the determined query for nearby food and restaurants.

After outputting graphical elements 128D-128F, computing device 10 may receive an indication of user input selecting graphical element 128D, which is associated with the query for current movies playing in nearby theatres. Upon receiving the selection, computing device 10 may execute the search query for current movies playing in nearby theatres and retrieve a set of search results from the Internet. The search results may include four different movies that are playing in theatres geographically close to computing device 10. Computing device 10 may output graphical user interface 114E, which includes four graphical indications 130A-130D of the four respective movies in the search results.

In the example of FIG. 4C, a display of computing device 10 may be in a portrait display mode (i.e., the vertical length of the display is greater than the horizontal length of the display). As such, computing device 10 may output graphical indications 130A-130D in a vertical orientation. In other examples, however, the display of computing device 10 may he in a landscape display mode (i.e., the horizontal length of the display is greater than the vertical length of the display). In such examples, computing device 10 may output graphical indications 130A-130D in a horizontal orientation.

In some instances, computing device 10 may receive an indication of user input selecting the search result associated with graphical indication 130B. Responsive to receiving the selection, computing device 10 may send a message to the second computing device that includes the search result associated with graphical indication 1303. In this way, techniques of this disclosure may reduce the amount of rime and the number of user inputs required to obtain and distribute relevant search results, which may simplify the user experience and may reduce power consumption of computing device 10.

Responsive to sending the message to the second computing device, computing device 10 output graphical user interface 114E In the example of FIG, 4C, graphical user interface 114F includes output region 118C, search key 116, and graphical keyboard 119A. Output region 118C may include the subsequent text message sent by the user of the second computing device to the user of computing device 10, as well as the message sent by the user of computing device 10 that includes graphical indication 130B associated with the selected search result from graphical user interface 114E.

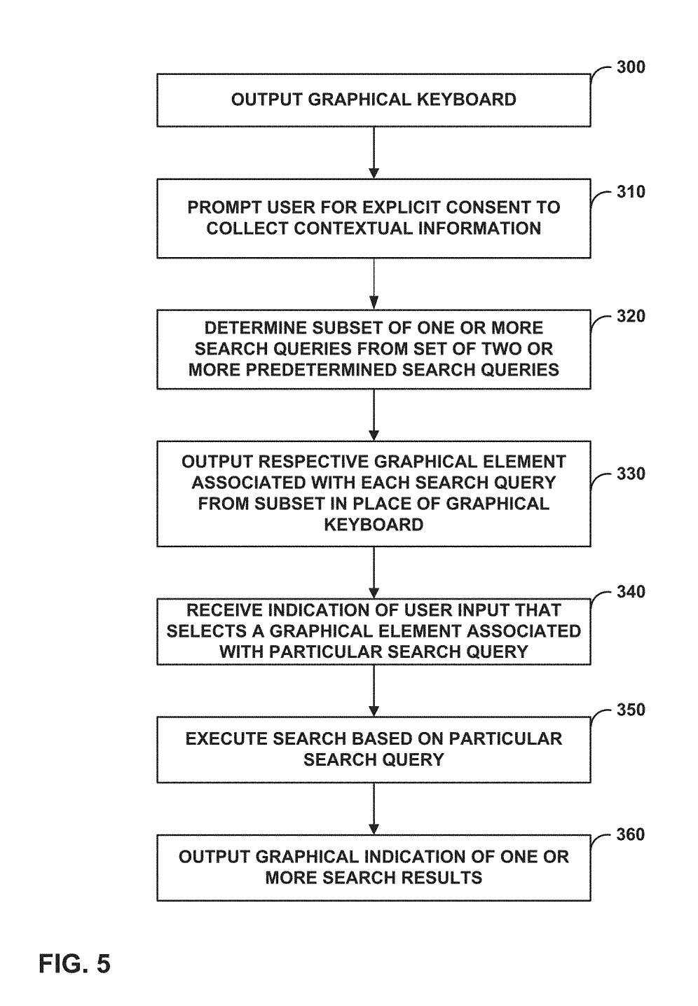

FIG. 5 is a flowchart illustrating example operations of a computing device that executes an application extension that is configured to dynamically determine a subset of predetermined search queries, in accordance with one or more aspects of the present disclosure. The operations of FIG. 5 may be performed by one or more processors of a computing device, such as computing devices 10 of FIG. 1 or FIG. 2. For purposes of illustration only, FIG. 5 is described below within the context of computing device 10 of FIG. 1.

In accordance with the techniques of this disclosure, computing device 10 may execute application module 22 to initially output, for display at PSD 12, a graphical keyboard (300). In such instances, application module 22 may be initially configured to receive inputs that result in entering text to be included into messages. While computing device 10 is outputting the graphical keyboard for display at PSD 12, application module 22 may activate application extension 23 to toggle application module 22 from a text-entry mode into a search mode. In some instances, application module 22 may activate application extension 23 in response to receiving some indication of user input, such as a selection of a search key. In other instances, application module 22 may automatically activate application extension 23 upon the execution of application module 22.

In the example of FIG. 5, a user of computing device 10 may be exchanging text messages with another user with a second computing device. Computing device 10 may send a first text message to the second computing device that includes the message “This Miami game is crazy right now!” At some later time, computing device 10 may receive a second text message from the second computing device that includes the message “What's the score?”

Prior to collecting contextual information, computing device 10 may prompt a user of computing device 10 for explicit consent to collect the contextual information (310). The contextual information may include one or more of calendar data, message data, a current time, a current location, a user account associated with application module 22, a search history, and message recipient data, among other things. For example, prior to retaining contextual information associated with the user of computing device 10, computing device 10 may present a user interface via PSD 12 that requests a user to select a box, click a button, state a voice input, or otherwise provide a specific input to the user interface that is interpreted by computing device 10 as unambiguous, affirmative consent for application extension 23 to collect and make use of the user's personal information and the contextual information. At this point, computing device 10 may continue to execute the remainder of the techniques described herein. For instance, after computing device 10 receives user input indicating that the user consents to the collection of the contextual information about the user and device information describing computing device 10 or a surrounding environment of computing device 10, computing device 10 may proceed to collect said contextual information.

Responsive to being activated by application module 22, and after receiving explicit consent to do so, application extension 23 may determine, based on contextual information associated with computing device 10, a subset of one or more search queries from a predetermined set of two or more search queries (320). The predetermined set of search queries may include any pre-loaded or custom-created search queries stored in memory on computing device 10. The search queries may include a recent search query, a query for nearby food and restaurants, a general query for what is near the current location of computing device 10, a query for nearby entertainment, a query for nearby activities, a query for currently trending topics on a social media platform, a query for recent videos, a query for nearby bars, a query for the current weather, a query for current movies being shown in nearby theatres, a query for current scores of sporting events, or any other query, custom or otherwise, that may be of relevance to a user in a text message conversation. Application extension 23 may select one or more of the predetermined search queries based on the previously collected contextual information to complete a subset of one or more search queries.

In the example of FIG. 5, application extension 23 may analyze the message data of the text messages previously exchanged between computing device 10 and the second computing device to determine the subset of search queries. Application extension 23 may determine that both of the text messages exchanged between computing device 10 and the second computing device include comments regarding a sporting event that includes a team from Miami, including a question from the second computing device regarding the current score of the event. As such, one of the selected search queries from the predetermined set may be a query for the current scores of sporting events, with the top results including scores for the Miami event. Application extension 23 may further determine that one of the text messages sent by the user contains the words “game is crazy.” As such, another selected search query from the predetermined set may be a query for recent videos, including videos from the Miami sporting event.

Responsive to application extension 23 determining the subset of search queries, application extension 23 may output, via UI module 20, for display in PSD 12, a respective graphical element associated with each search query from the subset of one or more search queries in place of at least a portion of the graphical keyboard (330). For instance, in the example of FIG. 5, application extension 23 determined the subset of search queries to be a query for the current scores of sporting events and a query for recent videos, including videos from the Miami sporting event. Application extension 23 may output a graphical interface that replaces the graphical keyboard with a search interface, which may include the graphical elements associated with the determined search queries.

Computing device 10 may receive an indication of user input that selects a respective graphical element associated with a particular search query from the subset of one or more search queries (340). Computing device 10 may execute a search based on the particular search query (350) and output, for display on PSD 12, a graphical indication of one or more search results determined from the executed search in place of at least the portion of the graphical keyboard (360). In some instances, application extension 23 of computing device 10 may perform the search. In other instances, a different search application may ultimately perform the search, such as application module 22, a search application executing at computing device 10, or a search application that is executing at a remote computing device (e.g., a server) and accessible to computing device 10 (e.g., via a network connection).

For example, application extension 23 may receive an indication of user input selecting the graphical element associated with the query for recent videos including videos of the Miami sporting event. Responsive to receiving this selection, application extension 23 may execute the search query for the recent videos from the Miami sporting event via a web search. In executing the search query, application module 22 may retrieve one or more videos of the Miami sporting event from the Internet. The search results could include a webpage having a video, or a graphical card that includes the video. Responsive to receiving these search results, application extension 23 may utilize UI module 20 to output a respective graphical indication for each of the one or more search results for display on PSD 12, such as in the place of the graphical keyboard and the search interface.

### Example 1

A method comprising: outputting, by an application executing at a computing device, for display, a graphical keyboard comprising a plurality of keys; determining, by an application extension of the application, based on contextual information associated with the computing device, a subset of one or more search queries from a predetermined set of two or more search queries; outputting, by the application extension, for display, in place of at least a portion of the graphical keyboard, a respective graphical element associated with each search query from the subset of one or more search queries; receiving, by the application extension, an indication of user input that selects the respective graphical element associated with a particular search query from the subset of one or more search queries; executing, based on the particular search query, a search; and outputting, by the application extension, for display, in place of at least the portion of the graphical keyboard, a graphical indication of one or more search results determined from the search.

### Example 2

The method of example 1, wherein determining the subset of the one or more search queries comprises: generating, by the application extension and based on the contextual information, a respective relevancy score for each search query in the predetermined set of two or more search queries, wherein the subset of one or more search queries are determined to be the one or more search queries in the predetermined set of two or more search queries that have the highest respective relevancy scores.

### Example 3

The method of example 2, wherein outputting the respective graphical elements comprises: determining, by the application extension, based on the respective relevancy score for each search query in the subset of one or more search queries, an order for the one or more search queries in the subset of one or more search queries; and outputting, by the application extension, for display, in place of at least the portion of the graphical keyboard and in accordance with the order, the respective graphical element associated with each search query from the subset of the one or more search queries.

### Example 4

The method of any of examples 1-3, wherein the contextual information comprises one or more of calendar data, message data, a current time, a current location, a search history associated with a user of the computing device, a user account associated with the application, a crowdsourced search history associated with users of other computing devices, and message recipient data.

### Example 5

The method of example 4, wherein the contextual information comprises the search history associated with the user of the computing device, and the method further comprises: responsive to receiving the indication of user input that selects the respective graphical element associated with the particular search query from the subset of one or more search queries, updating the search history based on the selection of the particular search query.

### Example 6

The method of any of examples 1-5, further comprising: downloading, by the computing device, from an application-extension distribution platform, the application extension; prior to determining the subset of one or more search queries, installing, by the application, the application extension.

### Example 7

The method of any of examples 1-6, wherein outputting the graphical indication of one or more search results further comprises: determining, by the computing device, whether the computing device is in a portrait display mode or a landscape display mode; if the computing device is in the portrait display mode, outputting, by the application extension, for display, in place of at least the portion of the graphical keyboard, the graphical indication of one or more search results determined from the search in a vertical orientation; and if the computing device is in the landscape display mode, outputting, by the application extension, for display, in place of at least the portion of the graphical keyboard, the graphical indication of one or more search results determined from the search in a horizontal orientation.

### Example 8

The method of any of examples 1-7, wherein each respective graphical element associated with each search query from the subset of one or more search queries has a unique visual characteristic that is indicative of the respective search query.

### Example 9

The method of any of examples 1-8, further comprising: receiving, by the computing device, an indication of second user input that selects the respective graphical element associated with a particular search result from the one or more search results; and sending, by the computing device, a message that includes the particular search result to a recipient client device.

### Example 10

The method of any of examples 1-9, wherein executing the search comprises executing, based on the particular search query and by one of the application extension or a search application, the search, wherein the one or more search results are retrieved from one of a memory of the computing device or from a server device.

### Example 11

A mobile device comprising: a presence-sensitive display component; at least one processor; and a memory that stores instructions associated with an application that when executed cause the at least one processor to: output, for display at the presence-sensitive display component, a graphical keyboard comprising a plurality of keys; determine, by an application extension of the application, based on contextual information associated with the computing device, a subset of one or more search queries from a predetermined set of two or more search queries; output, by the application extension, for display at the presence-sensitive display component, in place of at least a portion of the graphical keyboard, a respective graphical element associated with each search query from the subset of one or more search queries; receive, by the application extension and at the presence-sensitive display component, an indication of user input that selects the respective graphical element associated with a particular search query from the subset of one or more search queries; execute, based on the particular search query, a search; and output, by the application extension, for display at the presence-sensitive display component, in place of at least the portion of the graphical keyboard, a graphical indication of one or more search results determined from the search.

### Example 12

The mobile device of example 11, wherein the instructions that cause the at least one process to determine the subset of the one or more search queries comprise instructions that, when executed, cause the at least one processor to: generate, by the application extension and based on the contextual information, a respective relevancy score for each search query in the predetermined set of two or more search queries, wherein the subset of one or more search queries are determined to be the one or more search queries in the predetermined set of two or more search queries that have the highest respective relevancy scores.

### Example 13

The mobile device of example 12, wherein the instructions that cause the at least one process to output the respective graphical elements comprise instructions that, when executed, cause the at least one processor to: determining, by the application extension, based on the respective relevancy score for each search query in the subset of one or more search queries, an order for the one or more search queries in the subset of one or more search queries; and outputting, by the application extension, for display, in place of at least the portion of the graphical keyboard and in accordance with the order, the respective graphical element associated with each search query from the subset of the one or more search queries.

### Example 14

The mobile device of any of examples 11-13, Wherein the instructions, when executed, further cause the at least one processor to: downloading, by the computing device, from an application-extension distribution platform, the application extension; prior to determining the subset of one or more search queries, installing, by the application, the application extension.

### Example 15

The mobile device of any of examples 11-14, wherein the instructions that cause the at least one process to output the graphical indication of one or more search results further comprise instructions that, when executed, cause the at least one processor to: determining, by the computing device, whether the computing device is in a portrait display mode or a landscape display mode; if the computing device is in the portrait display mode, outputting, by the application extension, for display, in place of at least the portion of the graphical keyboard, the graphical indication of one or more search results determined from the search in a vertical orientation; and if the computing device is in the landscape display mode, outputting, by the application extension, for display, in place of at least the portion of the graphical keyboard, the graphical indication of one or more search results determined from the search in a horizontal orientation.

### Example 16

The mobile device of any of examples 11-15, wherein each respective graphical element associated with each search query from the subset of one or more search queries has a unique visual characteristic that is indicative of the respective search query.

### Example 17

The mobile device of any of examples 11-16, wherein the instructions, when executed, further cause the at least one processor to: receiving, by the computing device, an indication of second user input that selects the respective graphical element associated with a particular search result from the one or more search results; and sending, by the computing device, a message that includes the particular search result to a recipient client device.

### Example 18

A non-transitory computer-readable storage medium storing instructions associated with an application that, when executed, cause at least one processor of a computing device to: output, for display, a graphical keyboard comprising a plurality of keys; determine, by an application extension of the application, based on contextual information associated with the computing device, a subset of one or more search queries from a predetermined set of two or more search queries; output, by the application extension, for display, in place of at least a portion of the graphical keyboard, a respective graphical element associated with each search query from the subset of one or more search queries; receive, by the application extension, an indication of user input that selects the respective graphical element associated with a particular search query from the subset of one or more search queries; execute, based on the particular search query, a search; and output, by the application extension, for display, in place of at least the portion of the graphical keyboard, a graphical indication of one or more search results determined from the search.

### Example 19

The non-transitory computer-readable storage medium of example 18, wherein the instructions that cause the at least one process to determine the subset of the one or more search queries comprise instructions that, when executed, cause the at least one processor to: generate, by the application extension and based on the contextual information, a respective relevancy score for each search query in the predetermined set of two or more search queries, wherein the subset of one or more search queries are determined to be the one or more search queries in the predetermined set of two or more search queries that have the highest respective relevancy scores.

### Example 20

The non-transitory computer-readable storage medium of example 19, wherein the instructions that cause the at least one process to output the respective graphical elements comprise instructions that, when executed, cause the at least one processor to: determining, by the application extension, based on the respective relevancy score for each search query in the subset of one or more search queries; an order for the one or more search queries in the subset of one or more search queries; and outputting, by the application extension, for display, in place of at least the portion of the graphical keyboard and in accordance with the order, the respective graphical element associated with each search query from the subset of the one or more search queries.

### Example 21

A system comprising means for performing any of the methods of examples 1-10.

### Example 22

A computing device comprising means for performing any of the methods of examples 1-10.

### Example 23

A computer-readable storage medium comprising instructions that, when executed by at least one processor of a computing device, cause the at least one processor to perform any of the methods of examples 1-10.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

1. A method comprising:
outputting, by an application executing at a computing device, for display, a graphical keyboard comprising a plurality of keys;
determining, by an application extension of the application, based on contextual information associated with the computing device, a subset of one or more search queries from a predetermined set of two or more search queries;
outputting, by the application extension, for display, in place of at least a portion of the graphical keyboard, a respective graphical element associated with each search query from the subset of one or more search queries;
receiving, by the application extension, an indication of user input that selects the respective graphical element associated with a particular search query from the subset of one or more search queries;
executing, based on the particular search query, a search; and
outputting, by the application extension, for display, in place of at least the portion of the graphical keyboard, a graphical indication of one or more search results determined from the search.

2. The method of claim 1, wherein determining the subset of the one or more search queries comprises:
generating, by the application extension and based on the contextual information, a respective relevancy score for each search query in the predetermined set of two or more search queries,
wherein the subset of one or more search queries are determined to be the one or more search queries in the predetermined set of two or more search queries that have the highest respective relevancy scores.

3. The method of claim 2, wherein outputting the respective graphical elements comprises:
determining, by the application extension, based on the respective relevancy score for each search query in the subset of one or more search queries, an order for the one or more search queries in the subset of one or more search queries; and
outputting, by the application extension, for display, in place of at least the portion of the graphical keyboard and in accordance with the order, the respective graphical element associated with each search query from the subset of the one or more search queries.

4. The method of claim I, wherein the contextual information comprises one or more of calendar data, message data, a current time, a current location, a search history associated with a user of the computing device, a user account associated with the application, a crowdsourced search history associated with users of other computing devices, and message recipient data.

5. The method of claim 4, wherein the contextual information comprises the search history associated with the user of the computing device, and the method further comprises:
responsive to receiving the indication of user input that selects the respective graphical element associated with the particular search query from the subset of one or more search queries, updating the search history based on the selection of the particular search query.

6. The method of claim 1, further comprising:
downloading, by the computing device, from an application-extension distribution platform, the application extension;
prior to determining the subset of one or more search queries, installing, by the application, the application extension.

7. The method of claim 1, wherein outputting the graphical indication of one or more search results further comprises:
determining, by the computing device, whether the computing device is in a portrait display mode or a landscape display mode;
if the computing device is in the portrait display mode, outputting, by the application extension, for display, in place of at least the portion of the graphical keyboard, the graphical indication of one or more search results determined from the search in a vertical orientation; and
if the computing device is in the landscape display mode, outputting, by the application extension, for display, in place of at least the portion of the graphical keyboard, the graphical indication of one or more search results determined from the search in a horizontal orientation.

8. The method of claim 1, wherein each respective graphical element associated with each search query from the subset of one or more search queries has a unique visual characteristic that is indicative of the respective search query.

9. The method of claim 1, further comprising:
receiving, by the computing device, an indication of second user input that selects the respective graphical element associated with a particular search result from the one or more search results; and
sending, by the computing device, a message that includes the particular search result to a recipient client device.

10. The method of claim 1, wherein executing the search comprises executing, based on the particular search query and by one of the application extension or a search application, the search, wherein the one or more search results are retrieved from one of a memory of the computing device or from a server device.

11. A mobile device comprising:
a presence-sensitive display component;
at least one processor; and
a memory that stores instructions associated with an application that when executed cause the at least one processor to:
output, for display at the presence-sensitive display component, a graphical keyboard comprising a plurality of keys;
determine, by an application extension of the application, based on contextual information associated with the computing device, a subset of one or more search queries from a predetermined set of two or more search queries;
output, by the application extension, for display at the presence-sensitive display component, in place of at least a portion of the graphical keyboard, a respective graphical element associated with each search query from the subset of one or more search queries;
receive, by the application extension and at the presence-sensitive display component, an indication of user input that selects the respective graphical element associated with a particular search query from the subset of one or more search queries;
execute, based on the particular search query, a search; and
output, by the application extension, for display at the presence-sensitive display component, in place of at least the portion of the graphical keyboard, a graphical indication of one or more search results determined from the search,

12. The mobile device of claim 11, wherein the instructions that cause the at least one process to determine the subset of the one or more search queries comprise instructions that, when executed, cause the at least one processor to:
generate, by the application extension and based on the contextual information, a respective relevancy score for each search query in the predetermined set of two or more search queries,
wherein the subset of one or more search queries are determined to be the one or more search queries in the predetermined set of two or more search queries that have the highest respective relevancy scores.

13. The mobile device of claim 12, wherein the instructions that cause the at least one process to output the respective graphical elements comprise instructions that, when executed, cause the at least one processor to:
determining, by the application extension, based on the respective relevancy score for each search query in the subset of one or more search queries, an order for the one or more search queries in the subset of one or more search queries; and
outputting, by the application extension, for display, in place of at least the portion of the graphical keyboard and in accordance with the order, the respective graphical element associated with each search query from the subset of the one or more search queries.

14. The mobile device of claim 11, wherein the instructions, when executed, further cause the at least one processor to:
downloading, by the computing device, from an application-extension distribution platform, the application extension;
prior to determining the subset of one or more search queries, installing, by the application, the application extension.

15. The mobile device of claim 11, wherein the instructions that cause the at least one process to output the graphical indication of one or more search results further comprise instructions that, when executed, cause the at least one processor to:
determining, by the computing device, whether the computing device is in a portrait display mode or a landscape display mode;
if the computing device is in the portrait display mode, outputting, by the application extension, for display, in place of at least the portion of the graphical keyboard, the graphical indication of one or more search results determined from the search in a vertical orientation; and
if the computing device is in the landscape display mode, outputting, by the application extension, for display, in place of at least the portion of the graphical keyboard, the graphical indication of one or more search results determined from the search in a horizontal orientation.

16. The mobile device of claim 11, wherein each respective graphical element associated with each search query from the subset of one or more search queries has a unique visual characteristic that is indicative of the respective search query.

17. The mobile device of claim 1, wherein the instructions, when executed, further cause the at least one processor to:
receiving, by the computing device, an indication of second user input that selects the respective graphical element associated with a particular search result from the one or more search results; and
sending, by the computing device, a message that includes the particular search result to a recipient client device.

18. A non-transitory computer-readable storage medium storing instructions associated with an application that, when executed, cause at least one processor of a computing device to:
output, for display, a graphical keyboard comprising a plurality of keys;
determine, by an application extension of the application, based on contextual information associated with the computing device, a subset of one or more search queries from a predetermined set of two or more search queries;
output, by the application extension, for display, in place of at least a portion of the graphical keyboard, a respective graphical element associated with each search query from the subset of one or more search queries;
receive, by the application extension, an indication of user input that selects the respective graphical element associated with a particular search query from the subset of one or more search queries;
execute, based on the particular search query, a search; and
output, by the application extension, for display, in place of at least the portion of the graphical keyboard, a graphical indication of one or more search results determined from the search.

19. The non-transitory computer-readable storage medium of claim 18, wherein the instructions that cause the at least one process to determine the subset of the one or more search queries comprise instructions that, when executed, cause the at least one processor to:
generate, by the application extension and based on the contextual information, a respective relevancy score for each search query in the predetermined set of two or more search queries,
wherein the subset of one or more search queries are determined to be the one or more search queries in the predetermined set of two or more search queries that have the highest respective relevancy scores.

20. The non-transitory computer-readable storage medium of claim 19, wherein the instructions that cause the at least one process to output the respective graphical elements comprise instructions that, when executed, cause the at least one processor to:
determining, by the application extension, based on the respective relevancy score for each search query in the subset of one or more search queries, an order for the one or more search queries in the subset of one or more search queries; and
outputting, by the application extension, for display, in place of at least the portion of the graphical keyboard and in accordance with the order, the respective graphical element associated with each search query from the subset of the one or more search queries.
